(19) United States
(12) Patent Application Publication
(10) Pub. No.: US 2008/0047130 A1
(43) Pub. Date: Feb. 28, 2008

(54) METHOD FOR FABRICATING ANTENNA UNITS

(75) Inventors: Shun-Tian Lin, Taipei (TW); Chao-Tsung Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ADVANCED CONNECTEK INC., Taipei (TW)

(21) Appl. No.: 11/844,362

(22) Filed: Aug. 24, 2007

(30) Foreign Application Priority Data
Aug. 25, 2006 (TW) 95131346

(51) Int. Cl. H01P 11/00

(52) U.S. Cl. 29/600

(57) ABSTRACT

A method of fabricating antenna units is described, including providing a conductive material and a dielectric material, laminating the conductive material and the dielectric material, press-cutting the conductive material to form therein circuits of a plurality of antenna units, removing the conductive material other than the circuits to form a composite structure, and cutting the composite structure to obtain the antenna units. Before each antenna unit is obtained through cutting, a chip may be bonded onto the circuit thereof and then packaged so that an RFID tag is obtained after the cutting. The method allows the manufacturer to conduct a fabricating process in high efficiency, low cost and little pollution in a continuous manner, and also allows each antenna to have a full receiving performance due to the precision of the process.

### CROSS-REFERENCE TO RELATED APPLICATION

This application claims the priority benefit of Taiwan application serial no. 95131346, filed Aug. 25, 2006. All disclosure of the Taiwan application is incorporated herein by reference.

### BACKGROUND OF THE INVENTION

1. Field of the Invention

This invention relates to fabrication of radio-frequency identification (RFID) devices, and more particularly to a method for fabricating antenna units, which allows the manufacturer to conduct a fabricating process in high efficiency, low cost and little pollution in a continuous manner and also allows each antenna to have a full receiving performance due to the precision of the process.

2. Description of the Related Art

A conventional method of fabricating an antenna unit includes stamp-cutting a metal sheet to obtain an antenna circuit and manually bonding the same onto a dielectric sheet. The method not only is time-consuming and costly but also brings the product a relatively large weight. Moreover, since the electromagnetic wave penetrate into the surface of the antenna by merely several microns in high-frequency applications, using a relatively thick metal sheet to form an antenna circuit not only brings the product a relatively large weight and a relatively high cost but also causes a waste.

On the other hand, an RFID tag that is also called an RFID transponder or inlay includes an IC chip and an antenna circuit, which is in most cases made by printing of a conductive silver or copper paste, etching of a Cu-foil or electrodeless Cu-plating, etc.

However, using conductive silver paste to print an antenna circuit not only costs much, but also makes a low yield and a receiving performance of merely about 50% for the product. Printing an antenna circuit with a conductive copper paste costs less, but the yield is still low and the receiving performance is merely about 40% for the product. The etching-based method makes a quite high yield and a receiving performance near 100%, but causes environmental pollution and costs much. In addition, fabricating an antenna circuit with electrodeless copper plating makes a relatively higher yield and a receiving performance about 90%, but causes environmental pollution and costs much.

### SUMMARY OF THE INVENTION

In view of the forgoing, this invention provides a method of fabricating antenna units, which allows the manufacturer to conduct a fabricating process in high efficiency, low cost and little pollution in a continuous manner, and also allows each antenna to have a fall receiving performance due to the precision of the process of the method.

The method of fabricating antenna units of this invention includes providing a conductive material and a dielectric material, laminating the two materials, press-cutting the conductive material to form therein the circuits of a plurality of antenna units, removing the conductive material other than the circuits, and cutting the resulting composite structure to obtain the plurality of antenna units.

Before each antenna unit is obtained through cutting, a chip may be bonded onto the circuit thereof and then packaged so that an RFID tag, which is also called an RFID transponder or an RFID inlay, is obtained after the cutting.

In some embodiments, the conductive material and the dielectric material are laminated before the conductive material is press-cut, wherein the conductive material is press-cut such that the circuits as formed are completely separated from or partially connected with the rest of the conductive material.

In some embodiments, the conductive material and the dielectric material are laminated after the conductive material is press-cut, wherein the conductive material is press-cut such that the circuits as formed are partially connected with the rest of the conductive material.

It is to be understood that both of the foregoing general description and the following detailed description are just exemplary, and are intended to provide further explanation of the invention as claimed.

### BRIEF DESCRIPTION OF THE DRAWINGS

FIG. 1 is a flow chart showing the fabrication of an antenna unit in a method of fabricating antenna units according to a first embodiment of this invention.

FIG. 2 is an illustration showing an example of a method of fabricating antenna units according to the first embodiment of this invention.

FIG. 3 is an illustration showing another example of a method of fabricating antenna units according to the first embodiment of this invention.

FIG. 4 is a flow chart showing the fabrication of an antenna unit in a method of fabricating antenna units according to a second embodiment of this invention.

FIG. 5 is an illustration showing an example of a method of fabricating antenna units according to the second embodiment of this invention.

FIG. 6 is an illustration showing another example of a method of fabricating antenna units according to the second embodiment of this invention.

### DESCRIPTION OF THE PREFERRED EMBODIMENTS

It is noted that the following embodiments and examples are intended to farther explain this invention but not to limit the scope of the same.

### First Embodiment

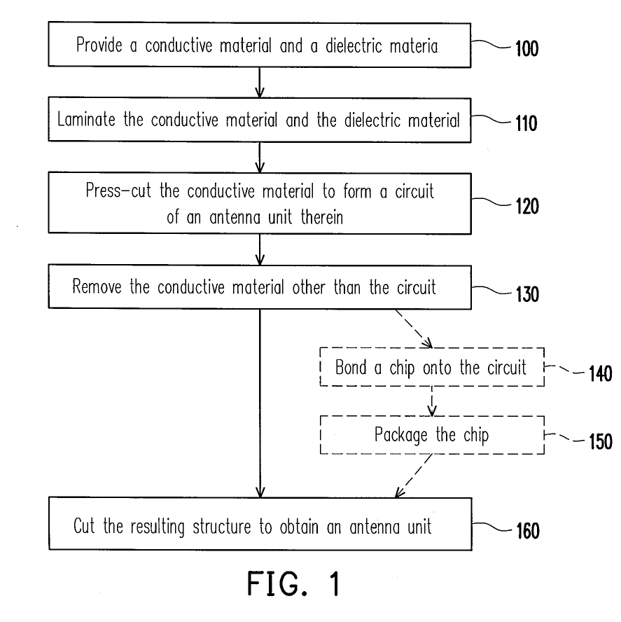

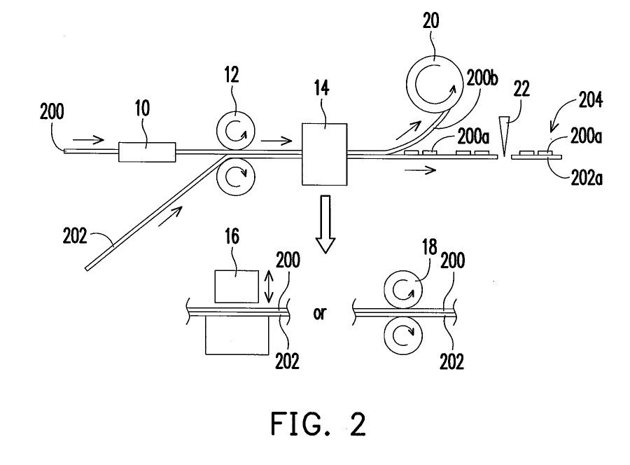

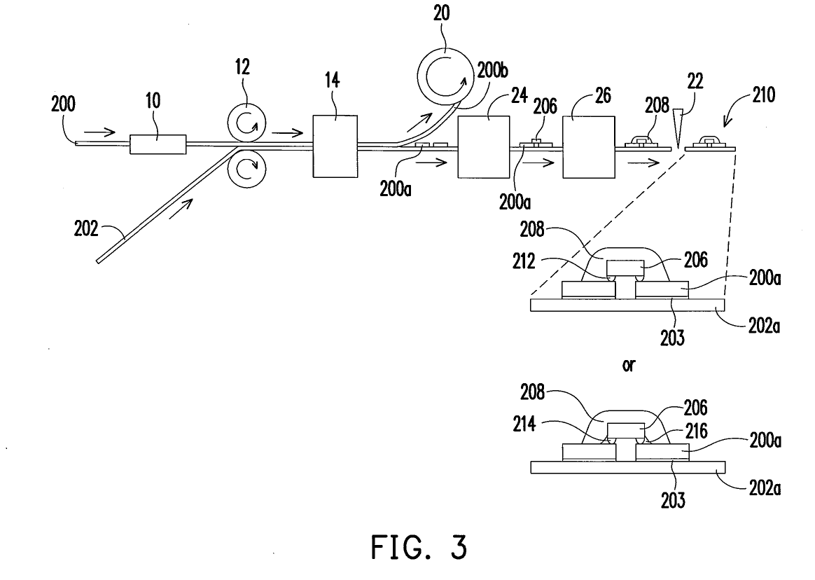

FIG. 1 is a flow chart illustrating the fabrication of an antenna unit in a method of fabricating antenna units according to the first embodiment of this invention. By establishing a continuous processing mechanism of multiple antenna units based on the steps of the fabrication of one antenna unit, multiple antenna units can be fabricated continuously. FIGS. 2 and 3 illustrate two examples of such a mechanism respectively.

Referring to FIGS. 1 and 2, a conductive material 200 and a dielectric material 202 are provided (step 100) in a continuous manner. Each of the materials 200 and 202 is preferably in the form of a contiguous film or tape, which may be stored in the form of a roll before being provided for the convenience of storage and continuous use.

Specifically, the conductive material can be a film of a metal or a metal alloy, or an insulating film coated with a metal or a metal alloy. The metal or metal alloy may include at least one material selected from the group consisting of gold (Au), silver (Ag), copper (Cu), aluminum (Al), nickel (Ni) and tin (Sn). The method of coating the insulating film with a metal or a metal alloy may be evaporation deposition or liquid plating, and the insulating film may include a polymer. The polymer may include at least one selected from a group including silicon rubber, neoprene rubber, acrylonitrile-butadiene rubber (NBR), styrene-butadiene rubber (SBR), polyacrylate, polyethylene (PE), thermoplastic elastomer (TPE) and polyethylene terephthalate (PET), etc.

In addition, the dielectric material 202 may include at least one selected from a group including polyethylene (PE), polyvinyl chloride (PVC), polypropylene (PP), polyethylene terephthalate (PET), acrylonitrile butadiene styrene (ABS) polymer, polycarbonate (PC), a mixture of ABS and PC, and paper, etc.

After the conductive material 200 and the dielectric material 202 are provided, they are laminated (step 110), possibly by using an applier 10 to apply an adhesive to at least one of respective surfaces to be joined of them and then press-bonding them by, for example, two opposite rollers 12. The adhesive may be applied along the patterns of the antenna circuits through screen printing or through the use of a spray gun controlled by a program, so that only the portions of the conductive material 200 to be separated as antenna circuits are bonded to the dielectric material 202 and the conductive material 200 other than the circuits can be removed easily. Alternatively, an adhesive having a relatively lower adhesion is applied all over at least one of the conductive material 200 and the dielectric material 202, wherein the adhesion thereof is sufficiently low so that the conductive material other than the circuits can be removed easily.

After the conductive material 200 and the dielectric material 202 are laminated, the conductive material 200 is press-cut with press-cutting means 14 to form therein a circuit 200a of an antenna unit (step 120). The press-cutting means 14 may include a stamp-cutting die 16 or a roll-cutting die 18. The die 16 or 18 may have thereon one or more patterns each being a relief-type pattern that corresponds to the boundary of the pattern of one circuit 200a, for the material between the circuit 200a and the rest (200b) of the conductive material 200 has to be thinned to allow separation of the circuit 200a.

The conductive material 200 may be press-cut such that the circuits 200a as formed are completely separated from or partially connected with the rest of the conductive material 200. In the later case, the connection sections between the circuits 200a and the rest of the conductive material 200 is preferably sufficiently thin so that the latter can be removed easily with a small force without damaging the structures of the circuits 200a or making the circuits 200a apart from the dielectric material 202.

After the press-cutting operation, the conductive material 200b other than the circuit 200a is removed (step 130), possibly with a tape winder 20 that is rotated to wind up the conductive material 200b. Preferably, the adhesive is applied along the pattern of the circuits 200a and the conductive material 200 is press-cut such that the circuits 200a as formed are completely separated from the conductive material 200b, so that the conductive material 200b can be removed relatively easily.

Thereafter, the resulting composite structure is cut to obtain an antenna unit 204 (step 160) possibly using a knife 22, wherein the cutting is usually done to the dielectric material 202 only or to a composite of the dielectric material 202 and a low-adhesion adhesive as mentioned above to form a dielectric base 202a of the antenna unit 204. In order to fabricate a plurality of antenna units in a continuous manner, it is possible to use a conveying mechanism (not shown), such as a conveyer belt, to continuously or intermittently forward the conductive material 200, the dielectric material 202 and their composite, so that a plurality of antenna units 204 can be cut-separated continuously. An important issue in the cutting is the positioning issue. For an intermittent forwarding mechanism, it is possible to set a positioning distance in advance and forward the composite structure by the positioning distance every time to achieve correct positioning. For a continuous one, it is possible to form positioning holes at the edges of the dielectric material film 202 so that the forwarding mechanism can stably forward the dielectric material 202 to achieve correct positioning.

FIG. 3 is an illustration showing another example of a method of fabricating antenna units according to the first embodiment of this invention. The example is different from the above one in that, before an antenna unit is cut-separated from the composite structure, a chip is bonded onto the circuit thereof and then packaged.

Referring to FIGS. 1 and 3, after the conductive material 200b other than the circuit 200a is removed, a chip 206 with an integrated circuit therein is bonded onto the circuit 200a (step 140) with bonding means 24 and packaged (step 150) with packaging means 26 that applies a molding compound 208 to cover the chip 206, so that an RFID tag 210 is obtained after the cutting. It is noted that the adhesive layer 203 in the magnified view of the RFID tag 210 in FIG. 3 is disposed only under the antenna circuit 200a as a result of applying the adhesive along the pattern of the circuit 200a previously.

In a case, the chip 206 to be bonded has solder balls 212 thereon and is directly soldered onto the circuit 200a with the solder balls 212. In another case, a polymer-based conductive material 216 is applied between the chip 206 and the circuit 200a and is baked to bond the chip 206 to the circuit 200a, wherein the polymer-based conductive material 216 may be previously applied to the surface of the chip 206 to be bonded. The polymer-based conductive material 216 may include an anisotropic conductive film (ACF) or an anisotropic conductive paste (ACP). In cases where an ACF or ACP is used for bonding, gold bumps 214 may be disposed on the chip 206 in advance. The portions of the ACF or ACP between respective gold bumps 214 and the circuit 200a form conductive paths after the gold bumps 214 is pressed over the circuit 200a.

### Second Embodiment

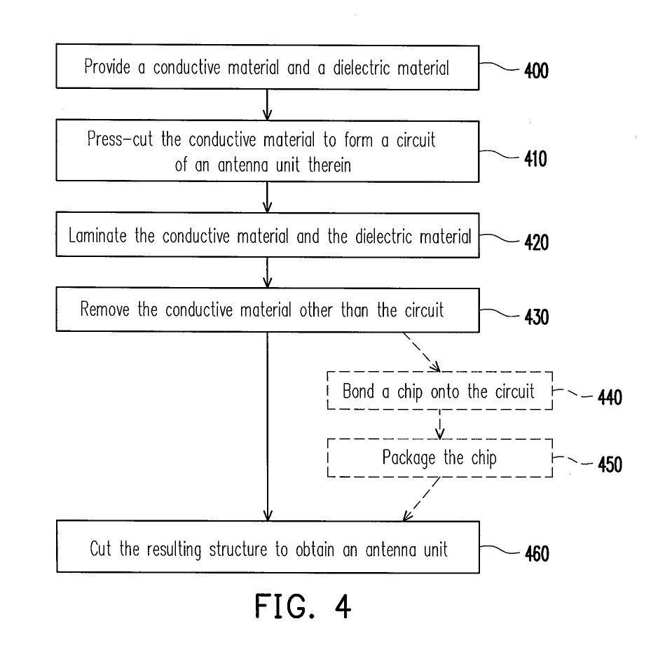

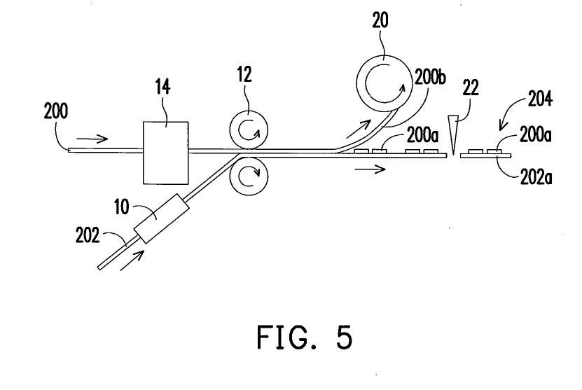

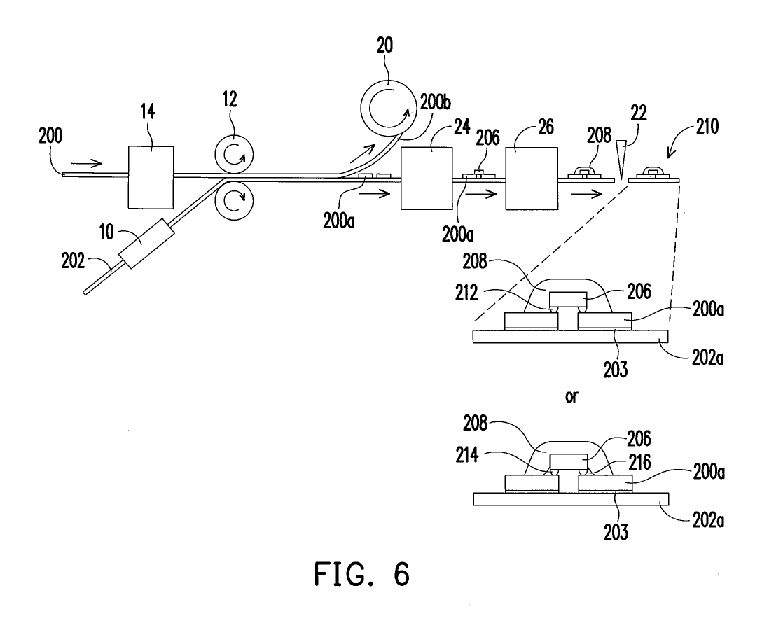

FIG. 4 is a flow chart illustrating the fabrication of an antenna unit in a method of fabricating antenna units according to the second embodiment of this invention. The second embodiment is different from the first embodiment in that the order of the lamination operation (420) and press-cutting operation (410) is reversed. The steps 400, 430, 440, 450 and 460 are similar to the steps 100, 130, 140, 150 and 160, respectively, and are therefore not described again. FIGS. 5 and 6 show two examples of such a method of fabricating antenna units. Since FIG. 5/6 is different from FIG. 2/3 merely in that the press-cutting means 14 is disposed before rather than after the two opposite rollers 12, the details of the operations corresponding to the steps 400-460 are similar to those of the operations corresponding to the steps 100-160 that have been mentioned in the first embodiment and are therefore not described again.

Nevertheless, in the second embodiment where the conductive material 200 is press-cut before being laminated with the dielectric material 202, the conductive material 200 is preferably press-cut such that the circuits 200a as formed are partially connected with the rest (200b) of the conductive material 200, so that the circuits 200a are stably forwarded together with the rest of the conductive material 200 and laminated with the dielectric material 202. The connection sections between the circuits 200a and the rest of the conductive material 200 is preferably sufficiently thin so that the rest of the conductive material 200 can be removed with a small force without damaging the circuits 200a or making the circuits 200a apart from the dielectric material 202.

By applying the method of this invention, a plurality of antenna units can be continuously fabricated in high efficiency, low cost and little pollution. The method also allows each antenna to have a fall receiving performance due to the precision of the process of the method.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A method for fabricating a plurality of antenna units, comprising:
providing a conductive material and a dielectric material;
laminating the conductive material and the dielectric material;
press-cutting the conductive material to form therein circuits of the plurality of antenna units;
removing the conductive material other than the circuits to form a composite structure; and
cutting the composite structure to obtain the plurality of antenna units.

2. The method of claim 1, further comprising:
before each of the antenna units is obtained through cutting, bonding a chip onto the circuit thereof and then packaging the chip.

3. The method of claim 2, wherein the chip to be bonded has solder balls thereon and is directly soldered onto the circuit with the solder balls.

4. The method of claim 2, wherein a polymer-based conductive material is applied between the chip and the circuit and is baked to bond the chip onto the circuit.

5. The method of claim 4, wherein the polymer-based conductive material is an anisotropic conductive film or an anisotropic conductive paste.

6. The method of claim 1, wherein the conductive material and the dielectric material are laminated before the conductive material is press-cut.

7. The method of claim 6, wherein the conductive material is press-cut such that the circuits as formed are completely separated from or partially connected with the rest of the conductive material.

8. The method of claim 1, wherein the conductive material and the dielectric material are laminated after the conductive material is press-cut.

9. The method of claim 8, wherein the conductive material is press-cut such that the circuits as formed are partially connected with the rest of the conductive material.

10. The method of claim 1, wherein the conductive material, the dielectric material and the composite structure are continuously or intermittently forwarded in a direction.

11. The method of claim 1, wherein the conductive material is a film of a metal or a metal alloy, or an insulating film coated with a metal or a metal alloy.

12. The method of claim 11, wherein the metal or metal alloy comprises at least one material selected from the group consisting of Au, Ag, Cu, Al, Ni and Sn.

13. The method of claim 11, wherein the insulating film is coated with the metal or metal alloy through evaporation deposition or through liquid plating.

14. The method of claim 11, wherein the insulating film comprises a polymer.

15. The method of claim 14, wherein the polymer comprises at least one selected from the group consisting of silicon rubber, neoprene rubber, acrylonitrile-butadiene rubber (NBR), styrene-butadiene rubber (SBR), polyacrylate, polyethylene (PE), thermoplastic elastomer (TPE) and polyethylene terephthalate (PET).

16. The method of claim 1, wherein the dielectric material comprises at least one material selected from the group consisting of polyethylene (PE), polyvinyl chloride (PVC), polypropylene (PP), polyethylene terephthalate (PET), acrylonitrile butadiene styrene (ABS) polymer, polycarbonate (PC), a mixture of ABS and PC, and paper.

17. The method of claim 1, wherein laminating the conductive material and the dielectric material comprises:
applying an adhesive to at least one of the conductive material and the dielectric material; and
press-bonding the conductive material and the dielectric material.

18. The method of claim 17, wherein the adhesive is applied along a pattern of each of the circuits through screen printing.

19. The method of claim 17, wherein the adhesive is applied along a pattern of each of the circuits using a spray gun controlled by a program.

20. The method of claim 17, wherein the adhesive is applied all over at least one of the conductive material, and the dielectric material and has a sufficiently low adhesion so that the conductive material other than the circuits can be removed smoothly.

21. The method of claim 17, wherein the conductive material and the dielectric material are press-bonded using two opposite rollers.

22. The method of claim 1, wherein press-cutting the conductive material comprises stamp-cutting or roll-cutting the conductive material.

23. The method of claim 22, wherein the conductive material is stamp-cut or roll-cut such that the circuits as formed are completely separated from or partially connected with the rest of the conductive material.

24. The method of claim 1, wherein the conductive material is a contiguous tape and removing the conductive material other than the circuits is done by using a tape winder.

25. The method of claim 1, wherein cutting the composite structure to obtain the plurality of antenna units is done by using a knife.
